(19) United States
(12) Patent Application Publication
(10) Pub. No.: US 2026/0058300 A1
(43) Pub. Date: Feb. 26, 2026

(54) BATTERY CHARGING CABINET

(71) Applicant: Beam Bike Corp. DBA JOCO, New York, NY (US)

(72) Inventors: Jonathan Cohen, New York, NY (US); Jonathan A. Cohen, New York, NY (US); Joseph Mayonado, Merritt Island, FL (US)

(73) Assignee: Beam Bike Corp. DBA JOCO, New York, NY (US)

(21) Appl. No.: 19/221,579

(22) Filed: May 29, 2025

Related U.S. Application Data
(60) Provisional application No. 63/653,062, filed on May 29, 2024.

(51) Int. Cl. H01M 50/367; A62C 3/16; A62C 99/00; G08B 17/10; H01M 10/613; H01M 10/6551; H01M 10/6563; H01M 10/658; H01M 50/242; H01M 50/271; H01M 50/293; H01M 50/325; H01M 50/342; H01M 50/383

(52) U.S. Cl. CPC H01M 50/367; A62C 3/16; A62C 99/0063; G08B 17/10; H01M 10/613; H01M 10/6551; H01M 10/6563; H01M 10/658; H01M 50/242; H01M 50/271; H01M 50/293; H01M 50/325; H01M 50/3425; H01M 50/383; H01M 2200/10; H01M 2200/20

(57) ABSTRACT

The present device provides a storage cabinet for safely housing multiple rechargeable chemical batteries, comprising a fire-proof outer housing that defines an interior chamber; within the chamber, one or more battery storage compartments are arranged such that an insulating air-gap separates each compartment from every adjacent compartment; each battery compartment includes a closable access door that forms an air-tight seal; an ignition source is disposed within the interior chamber to deliberately ignite any combustible gas generated by a battery thermal event; and a ventilation system, having an inlet port for introducing ambient air into the interior chamber and an exhaust port leading to an external exhaust conduit and vent which is manages airflow and aids in controlled combustion and heat dissipation.

### CROSS-REFERENCE TO RELATED APPLICATIONS

This application is a U.S. Non-Provisional patent application which claims priority to U.S. Provisional Patent Application Ser. No. 63/653,062 filed on May 29, 2024, the entire contents of which are hereby incorporated by reference in their entirety as if fully set forth herein.

### TECHNICAL FIELD

The device of the instant application relates generally to the technical field of battery storage and charging cabinets. More particularly, the device of the instant application relates to fire-resistant, ventilated battery storage and charging cabinets configured to store and charge lithium-ion batteries while abating the flammable gases released during thermal runaway or overheating events by burning them off internally.

### BACKGROUND

As the adoption of rechargeable chemical batteries increases across industrial, commercial, and consumer applications, the risks associated with battery failure, particularly thermal runaway events, have become a growing safety concern. In particular, lithium-ion and other high-density battery chemistries are known to emit flammable and potentially explosive gases when subjected to overcharging, overheating, mechanical damage, or internal short circuits

In efforts to mitigate these risks, battery charging cabinets have been developed that incorporate fire-resistant materials, ventilation systems, and basic containment structures. Many such cabinets are designed with steel enclosures, thermal insulation, fume vents, and integrated fire suppression systems. Some models include limited forms of gas detection or circuit cutoff mechanisms.

However, existing battery charging cabinets suffer from several critical shortcomings including reliance on active fire suppression, lack of a flammable and/or combustible gas mitigation system, have inadequate flame arresting for exhaust gases, and insufficient deflagration management.

While many cabinets may control fire and thermal runaway propagation, they often allow for the release of hazardous flammable gases outside of the storage cabinet, depend upon unreliable fire suppression methods, lack integrated flame arresting systems to prevent flame propagation through the exhaust ducts.

Most commercially available systems rely on passive venting and fail to include any mechanism for actively neutralizing gases prior to exhaust. This omission increases the likelihood that ignitable vapor mixtures will accumulate and discharge into the surrounding environment. In high-risk applications, batteries may undergo partial combustion or deflagration within the cabinet. Few existing systems include designated deflagration chambers capable of safely containing and directing the explosive force of such an event. Additionally, lithium-ion fires are notoriously resistant to extinguishment from all known fire suppression agents. Active fire suppression systems may fail to adequately extinguish or suppress a thermal runaway event.

Existing systems are typically reactive rather than preventative. They may shut down charging after gas accumulation is detected but do not mitigate the accumulation of dangerous gases before an uncontrolled ignition event can occur. Current designs also lack purely passive to contain a fire and prevent propagation of thermal runaway.

### BRIEF SUMMARY

The ever-increasing energy density of lithium-ion batteries has allowed for a rapid growth in adoption of micro-electronic mobility devices such as e-bikes, e-scooters, as well as many other household and commercial appliances. Associated with this increase in energy density has also been an increase in the incidents of fire and explosions when these batteries fail. None of the safety products currently on the market are intended to nor able to eliminate the explosion hazards created by large consumer and commercial batteries if they vent large volumes of flammable or combustible gases. The chemical battery charging cabinet of the instant application is intended to overcome the shortcomings described by introducing a system which abates the fire and explosion risk from gases and cools them before emitting them to the surrounding environment. Each battery occupies a double walled sealed discrete storage compartment within the storage cabinet. The cabinet possesses an air gap between each compartment to inhibit thermal propagation between compartments. This space between compartments acts as an antechamber having at least one of redundant smoke detectors which are configured to actuate a redundant ignition source, i.e. sparker, which acts to ignite the flammable and combustible gases accumulating within the antechamber which also acts as a deflagration chamber. Gases are then passed through a baffled exhaust stack which acts both as a flame arrestor and a means to cool the heated gases. Although active ventilation is provided, it should be noted that they are not considered necessary to prevent thermal runaway propagation and the exhaust stack and one-way air supply vents create natural convective movement of the gases through the flame arrest system. In this way, the storage cabinet is considered to be fail-safe and reliant on entirely passive systems.

### BRIEF DESCRIPTION OF THE VIEWS OF THE DRAWINGS

To easily identify the discussion of any particular element or act, the most significant digit or digits in a reference number refer to the figure number in which that element is first introduced.

FIG. 1 illustrates a cutaway elevation view of the front of an embodiment of the claimed storage cabinet disclosing the battery storage compartments, the storage cabinet ventilation flow, and baffled exhaust conduit.

FIG. 2 illustrates a plan view of an embodiment of the claimed storage cabinet disclosing the exhaust vent.

FIG. 3 illustrates a cutaway perspective view of the rear of an embodiment of the claimed storage cabinet disclosing the baffled exhaust conduit.

FIG. 4 illustrates a plan cross-section view along line A-A of an embodiment of the claimed storage cabinet depicting the placement of the insulated electronics compartment and its components.

FIG. 5 illustrates a side elevation cutaway view of an embodiment of the ventilation conduit of the claimed storage cabinet.

FIG. 6 illustrates an elevation cutaway view of an embodiment of the ventilation conduit of the claimed storage cabinet.

FIG. 7 illustrates a cutaway side perspective view of an embodiment of the ventilation conduit of the claimed storage cabinet.

FIG. 8 illustrates a cutaway elevation view of an embodiment of the battery storage compartment of the claimed storage cabinet.

FIG. 8a illustrates a detail view of the cutaway elevation view of an embodiment of the battery storage compartment of the claimed storage cabinet illustrated in FIG. 8.

FIG. 9 illustrates an elevation view of an embodiment of the claimed storage cabinet

### DETAILED DESCRIPTION OF THE EMBODIMENTS

Various exemplary and preferred embodiments of the claimed device are described herein in reference to the drawings. This disclosure recognizes and addresses the previously-mentioned long-felt needs and provides utility in meeting those needs in various possible embodiments.

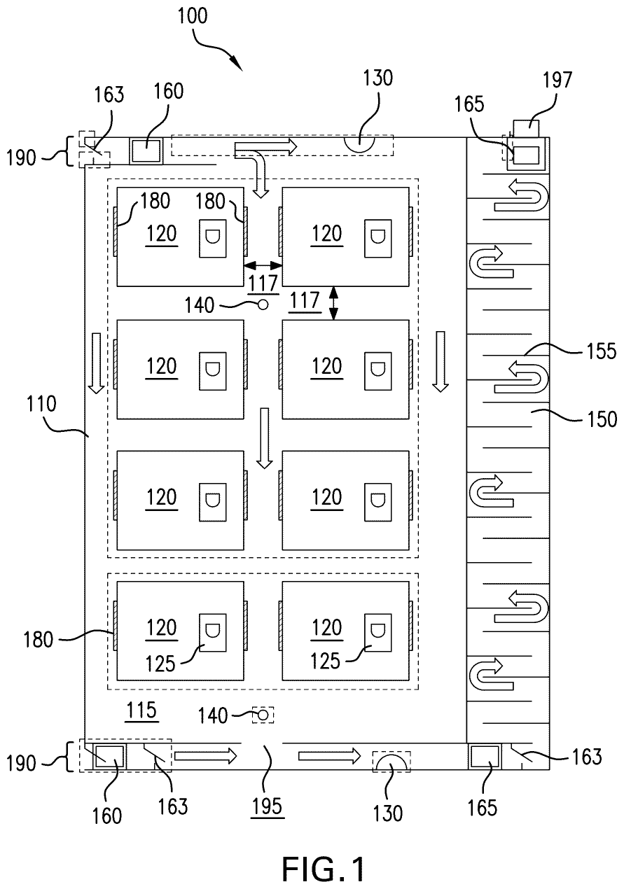

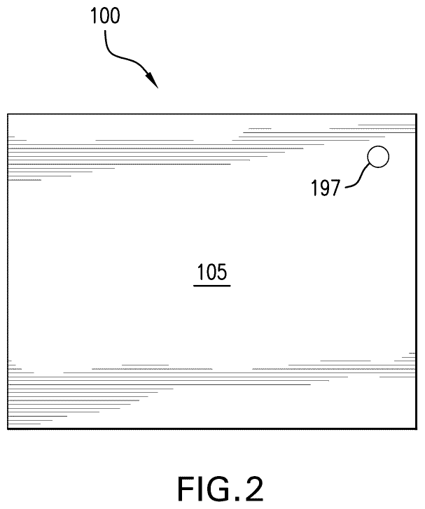

The storage cabinet 100 is commonly made from steel and as depicted in FIG. 1, typically comprises a plurality of individual rechargeable chemical battery storage compartments 120 arranged within a fire-resistant and explosion-resistant housing 110. Each rechargeable chemical battery storage compartment 120 is configured to receive one or more rechargeable chemical batteries and is individually sealed to prevent gas or flame propagation between rechargeable chemical battery storage compartments 120. Each is insulated from adjacent rechargeable chemical battery storage compartments 120 by being arranged within an interior chamber 115 within the storage cabinet 100 so that chemical battery storage compartments 120 are not in physical contact with each other but instead have an insulating air gap 117 between each respective rechargeable chemical battery storage compartments 120. As shown in FIG. 2, an exhaust vent 193 is provided on the top of the storage cabinet 100 to allow hot gases and combustion by-products to exit the storage cabinet 100. Each storage cabinet 100 also preferably utilizes an insulated electronics compartment 415 to protect the electronics and control system.

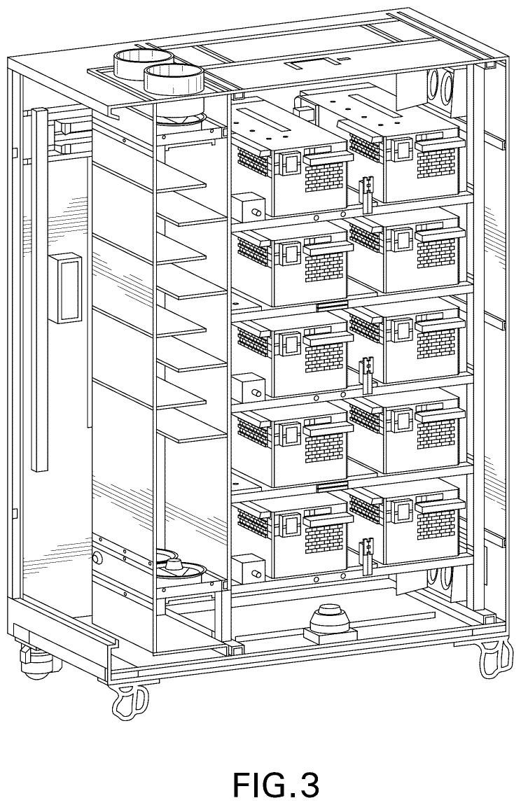

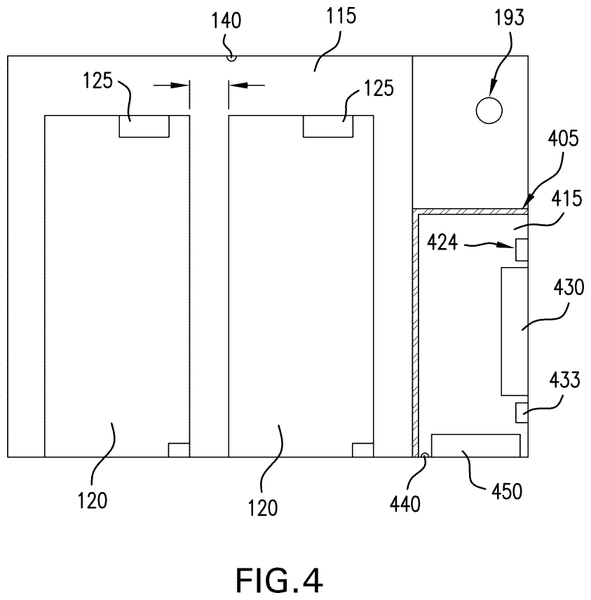

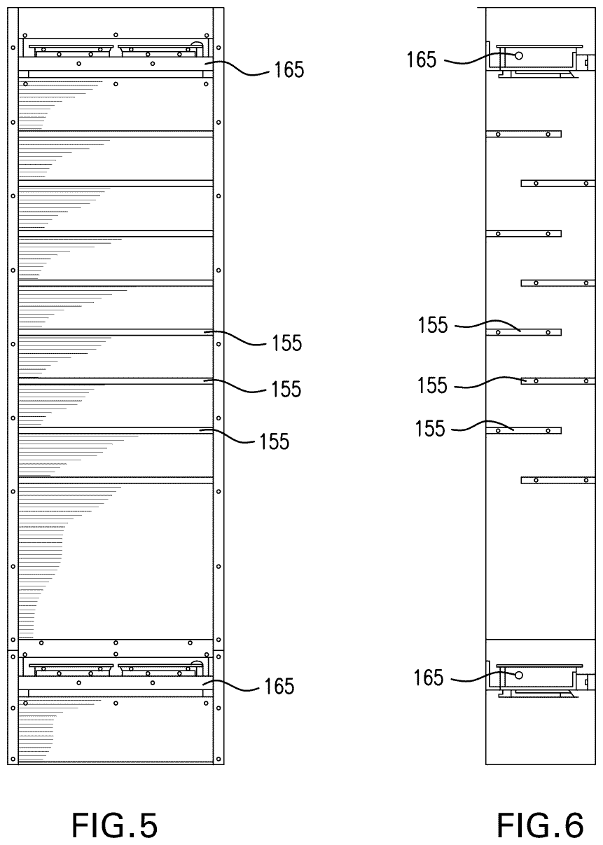

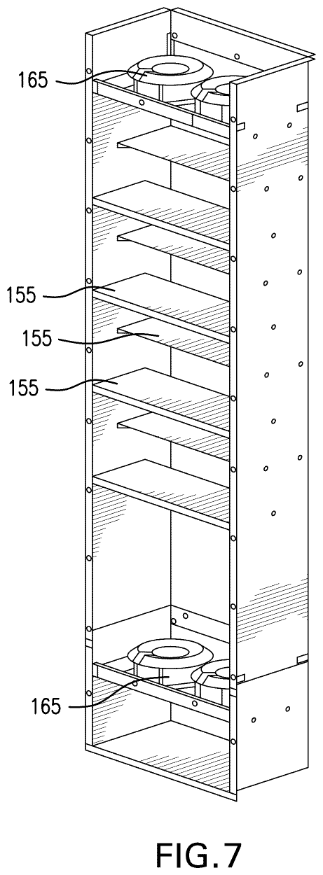

As depicted in FIG. 3 and FIG. 4, an insulated electronics compartment 415 is separated within the storage cabinet 100 by an insulated wall 405 preferably contains the control panel 430, the battery back-up unit, a wireless transmitter, a fire alarm dry contact 433, a sounder 440, a master power switch 424, and a user interface 450. Under normal operating conditions, the user interface 450 actuates the compartment access doors 175 to the rechargeable chemical battery storage compartments 120.

In a further embodiment, each rechargeable chemical battery storage compartment 120 has interior compartment walls 820 and an exterior compartment walls 830 with an insulating material 850 filling a wall void between the interior compartment walls 820 and the exterior compartment walls 830. Despite their sealed configuration, each rechargeable chemical battery storage compartment 120 is equipped with a pressure relief system 180 that allows thermal venting of gases generated during the charging of rechargeable chemical batteries, or rechargeable chemical battery failure.

FIG. 1 illustrates the typical arrangement of rechargeable chemical battery storage compartments 120 in the storage cabinet 100 relative to each other in the interior chamber. Each rechargeable chemical battery storage compartment 120 possesses a power outlet 125 for charging a rechargeable chemical battery. Each rechargeable chemical battery storage compartment 120 also possesses a pressure relief system 180 in the event of an accumulation of flammable gases from a rechargeable chemical battery.

The insulating voids between each rechargeable chemical battery storage compartment 120 inhibit the propagation of heat between them. Sparkers 140, i.e. ignition sources 140, are placed within the interior chamber for the purpose of igniting accumulated flammable gases, turning the interior chamber into a deflagration chamber. One-way air flaps 163 ensure that the air fed into and out of the storage cabinet 100 by the forced-air ventilation system will not backflow.

One-way air flaps 163, also known as backdraft dampers or check valves, are mechanical elements positioned at air inlets 190 and/or exhaust conduit 150 to permit airflow only in a predetermined direction. Specifically, inlet air flaps 163 are configured to open inwardly, allowing fresh air to enter under positive pressure (such as from a fan) and automatically close if internal pressure exceeds external pressure, thereby preventing reverse airflow and the unwanted release of internal gases or contaminants. Exhaust port air flaps 163 are arranged to open outwardly in response to internal pressure. When exhaust gases or air pressure increases internally, the flaps swing open, permitting gases to exit. If external pressure or conditions attempt to drive air backward into the conduit, the flaps 163 automatically seal shut, preventing external air from entering.

Air enters the storage cabinet 100 through inlet ports and exits the interior chamber via an exhaust port which leads to an exhaust conduit 150 which terminates at an exhaust vent 193 from which the storage cabinet 100 gases released. A ventilation system ensures the proper circulation of air through the storage cabinet 100 through the use of natural ventilation, inlet ventilation fans 160 and/or exhaust ventilation fans 165. As air is drawn through the interior chamber, flammable gases are removed. The airflow also acts as a heat transfer media to cool the antechamber 115 and its rechargeable chemical battery storage compartments 120.

The exhaust conduit 150, which begins at the exhaust port of the interior chamber, removes gases and heat from the storage cabinet 100. Baffles 155 are placed within the exhaust conduit 150 to increase the residence time of the interior chamber's gases and surface area to cool the gases. In an exemplary embodiment, the arrangement depicted in FIG. 1 utilizes alternating plates 155 to create a baffled exhaust stack 150, i.e. exhaust conduit 150, to increase the exit path surface area for the storage cabinet 100 exhaust. However, other types of baffles 155 such as angled or curved vanes, perforated plates, mesh screens, and spiral or helical inserts may also be utilized. The baffles 155 decrease the temperature and velocity of the exhaust gases which in turn inhibits the propagation of flames from burning gases and also acts to better cool the exhaust from the storage cabinet 100 by transferring heat to the environment surrounding the exhaust conduit 150 through a heat exchange process that is more effective at greater residence times.

The disclosed storage cabinet 100 mitigates the risk of fire and explosion related to the release of flammable gases emitted during thermal runaway or overheating of chemical batteries, such as lithium-ion batteries, by igniting the flammable gases within the antechamber 115, thus using it as a deflagration chamber to reduce the amount of flammable gas being vented through the exhaust vent 193. The sparkers 140 act to initiate combustion of flammable gases in a confined, managed environment to reduce or eliminate the potential for flame jets or explosions in the exhaust conduit 150 that may otherwise propagate from the exhaust vent 193 and endanger structures, equipment, or personnel. Typically, the sparkers are actuated by the storage cabinet 100 control system when the interior chamber smoke sensors 130 or heat sensors 130 indicate a problem with the environment within the storage cabinet 100.

Although each rechargeable chemical battery storage compartment 120 is sealed air-tight, they are also equipped with pressure relief systems 180. During thermal runaway, overcharging, overheating, and rechargeable chemical battery failure, flammable gases may be released from the rechargeable chemical battery. For example, during thermal runaway lithium-ion rechargeable chemical batteries can produce highly flammable gases such as hydrogen, methane, ethylene, and ethane. Lithium-ion rechargeable chemical batteries can also produce carbon monoxide, propylene, propane, and butane. During thermal runaway, the gas mixture from lithium-ion rechargeable chemical batteries consist primarily of flammable hydrocarbons and hydrogen.

Thermal runaway is a self-sustaining, uncontrollable chain reaction where an increase in temperature leads to conditions causing a further increase in temperature, ultimately resulting in rapid overheating, battery failure, fire, or explosion. Thermal runaway can be induced by overcharging, short-circuiting, physical damage to the rechargeable chemical battery, internal defects, impurities, and exposure to high temperatures. When a rechargeable chemical battery's internal temperature begins to rise, exothermic reactions begin and electrolytes and cathode/anode materials begin to break down which releases additional heat which accelerates the decomposition of the rechargeable chemical battery and makes the reaction self-sustaining. This leads to escalation of the rechargeable chemical battery breakdown which ignites released gases.

The heat and flames from thermal runaway in a rechargeable chemical battery can also trigger thermal runaway in adjacent batteries to create a cascading effect. The rechargeable chemical battery chemistries most commonly susceptible to thermal runaway are lithium-ion (especially high energy density cells), lithium polymer, lithium-metal, and nickel-based. If these flammable gases reach their lower-explosive-limit (LEL) and encounter a spark, a flame, or a hot surface an explosion or rapid combustion (deflagration) can occur. If no pressure relief mechanism is available the rechargeable chemical battery storage compartment 120 may violently rupture, compounding the problem.

In some instances, flames and flammable gases can propagate out of a storage cabinet 100 exhaust vent and into the environment. Potentially, all of the rechargeable chemical batteries stored in the storage cabinet 100 can be damaged. Notably, common fire extinguishing agents can also have a minimal effect on rechargeable chemical batteries. Ideally, the fire hazard from thermal runaway of rechargeable chemical batteries can best be mitigated by passive propagation resistance and flammable gas deflagration within the interior chamber of the storage cabinet 100 to burn off the flammable gases and cooling the combustion by-products prior to their exit into the environment around the storage cabinet 100.

As gases are released from rechargeable chemical batteries during thermal runaway, pressure builds within the rechargeable chemical battery storage compartment. Equipping rechargeable chemical battery storage compartments 120 with pressure relief systems 180 can minimize the risk and damage. Table 1 describes several types of pressure relief systems 180. Notably, some pressure relief systems 180 are reusable and will likely not require replacement after use. Pressure relief valves, check valves, sensor actuated active systems, or materials that change shape upon heating can be reused. However, some pressure relief systems destroy the pressure relief mechanism. Rupture disks, frangible panels, and frangible seals undergo irreversible mechanical failure to release pressure. Fusible plugs are designed to melt and also undergo an irreversible change to release pressure.

TABLE 1
Pressure Relief Systems

| Mechanism | Reusable | Trigger mechanism |
|---|---|---|
| Pressure Relief Valve | Yes | Pressure threshold |
| Rupture Disk | No | Pressure threshold |
| Frangible Seal | No | Pressure threshold |
| Frangible Panel | No | Pressure threshold |
| Fusible Plug | No | Temperature threshold |
| Thermal Vents | Yes | Temperature threshold |
| Check Valve | Yes | Pressure difference |
| Active Systems | Yes | Electronic sensor/actuator |

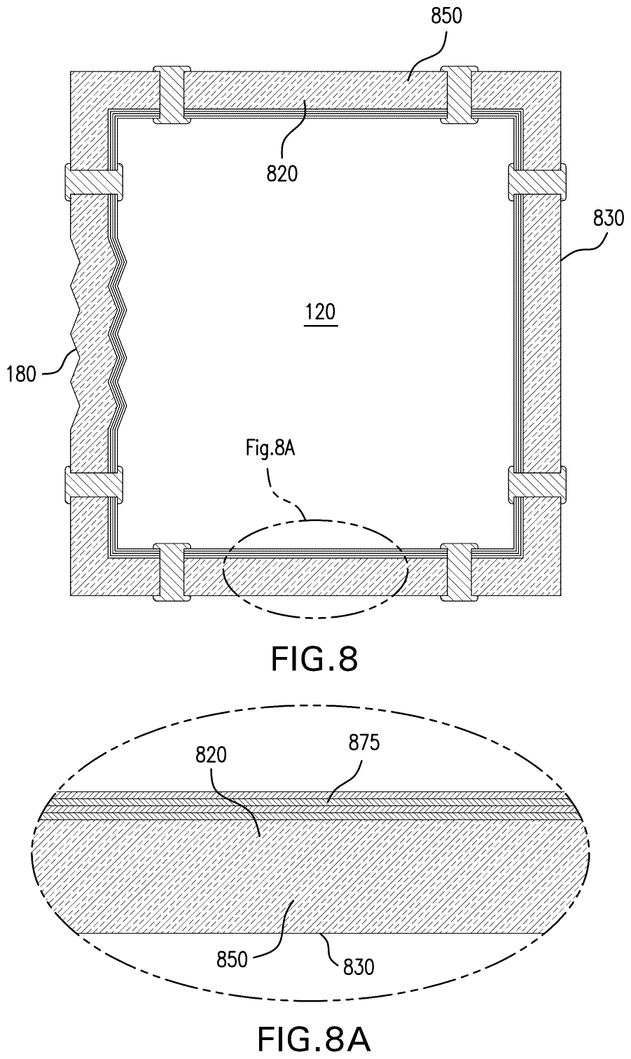

As depicted in FIG. 8, each rechargeable chemical battery storage compartment 120 possesses interior compartment walls 820 and exterior compartment walls 820. A mineral fiber insulation 850 is placed between the interior compartment walls 820 and exterior compartment walls 830. As demonstrated in Table 2, rock wool is a preferred mineral fiber insulation due to its very high temperature resistance and affordability. Ceramic fibers provide improved performance but at a significantly higher cost relative to rock wool and slag wool. Glass wool, i.e. fiberglass, can be cost effective and useful but it has a relatively low temperature resistance which is problematic given that hotspots can reach 1000° C. as shown in Table 3.1. In a further embodiment depicted in FIG. 8a, the interior compartment walls 820 of the rechargeable chemical battery storage compartment 120 are coated with an intumescent paint 875 or thermal barrier coating 875. The coating 875 helps to provide additional thermal insulation between storage compartments 120.

TABLE 2
Temperature Resistance of Mineral Fibers

| Mineral Fiber Type | Primary Material(s) | Temp. Resistance |
|---|---|---|
| Rock Wool | Basalt, volcanic rock | Very High (1200° C.+) |
| Slag Wool | Blast-furnace slag | High (~1000° C.) |
| Glass Wool | Glass, silica | Moderate (~500-700° C.) |
| Ceramic Fiber | Alumina, silica | Extreme (~1427° C.) |

TABLE 3
Lithium-Ion Battery Thermal Runaway Temperatures

| Component/Stage | Temperature Range | Description |
|---|---|---|
| Onset of thermal | ~80° C.-150° C. | Separator melts or electrolyte |
| runaway | (176° F.-302° F.) | begins to decompose |
| Accelerated | 200° C.-300° C. | Cathode and anode materials |
| exothermic reactions | (392° F.-572° F.) | react violently |
| Peak cell internal | 500° C.-800° C. | Full thermal runaway; self- |
| temperatures | (932° F.-1472° F.) | sustaining combustion |
| Localized hotspots | Up to 1000° C. | Short bursts during venting, |
| | (1832° F.) | arcing, or combustion |

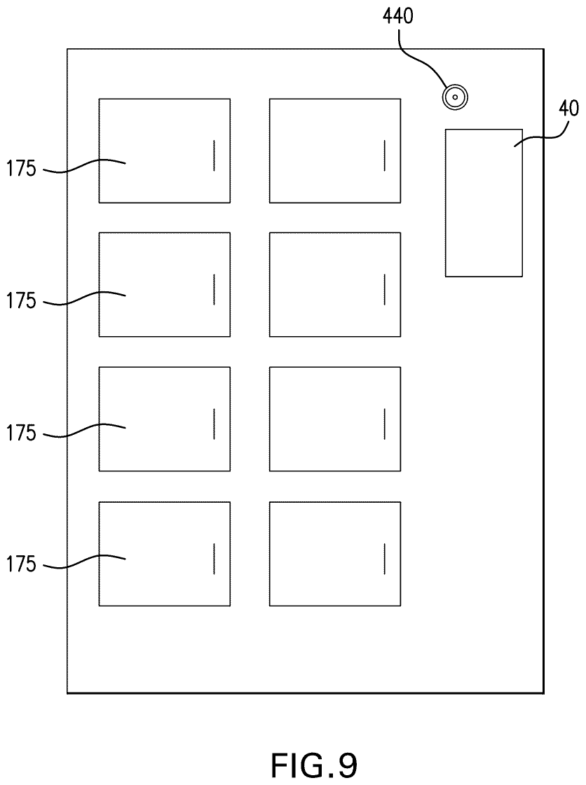

As illustrated in FIG. 9, the battery storage compartment doors 175 will be closed during charging. The front of the storage cabinet possesses a sounder to indicate an alarm and a control panel with which to operate the features of the storage cabinet.

To one of skill in this art who has the benefits of this disclosure's teachings, other and further objects and advantages may become clear, as well as others inherent therein. The disclosures herein are not intended to limit the scope of the patent claims, merely to provide context.

What is claimed is:

1. A storage cabinet comprising:
a fire-proof housing defining an interior chamber which houses a rechargeable chemical battery storage compartment arranged within said interior chamber so that an air-gap exists between said rechargeable chemical battery storage compartment and any adjacent rechargeable chemical battery storage compartment, wherein said rechargeable chemical battery storage compartment has a compartment access door operably coupled to said rechargeable chemical battery storage compartment and movable between an open position and a closed position which forms an air-tight seal around said compartment access door when secured in said closed position;
an ignition source within said interior chamber; and
a ventilation system having an inlet port to channel air into said interior chamber from outside of said storage cabinet, and an exhaust port to channel air out of said interior chamber and into an exhaust conduit outside of the interior chamber which terminates at an exhaust vent.

2. The storage cabinet of claim 1, wherein said rechargeable chemical battery storage compartment has interior compartment walls, exterior compartment walls, and an insulating material arranged between said interior compartment walls and said exterior compartment walls.

3. The storage cabinet of claim 2, wherein said insulating material is a mineral fiber comprised of the group consisting of rock wool, slag wool, glass wool, and ceramic fiber.

4. The storage cabinet of claim 2, wherein said interior compartment walls of said rechargeable chemical battery storage compartment have a thermal barrier coating.

5. The storage cabinet of claim 1, further comprising at least one of an inlet ventilation fan in communication with said inlet port and an exhaust ventilation fan in communication with said exhaust port.

6. The storage cabinet of claim 5, wherein at least one of said inlet port and said exhaust port have air flaps to prevent backflow.

7. The storage cabinet of claim 6, further comprising baffles arranged within said exhaust conduit between said exhaust port and said exhaust vent.

8. The storage cabinet of claim 7, wherein said baffles are selected from the group consisting of alternating plates, angled vanes, curved vanes, perforated plates, mesh, and helical inserts.

9. The storage cabinet of claim 8, wherein at least part of said exhaust conduit is arranged outside of said interior chamber between said exhaust port and said exhaust vent.

10. The storage cabinet of claim 1, wherein said rechargeable chemical battery storage compartment uses a pressure relief system to vent accumulated gases to said interior chamber.

11. The storage cabinet of claim 10, wherein said pressure relief system is selected from the group consisting of pressure relief valves, thermal vents, rupture disks, frangible seals, frangible panels, fusible plugs, check valves, and active pressure management systems.

12. The storage cabinet of claim 1, wherein said rechargeable chemical battery is selected from the group consisting of lithium-ion batteries, lithium polymer batteries, lithium iron phosphate batteries, lithium nickel manganese cobalt oxide batteries, lithium cobalt oxide batteries, nickel-metal hydride batteries, and nickel-cadmium batteries.

13. The storage cabinet of claim 12, wherein said rechargeable chemical battery storage compartment is configured to charge said rechargeable chemical battery.

14. The storage cabinet of claim 1, further comprising sensors selected from the group consisting of smoke sensors and heat sensors.

15. The storage cabinet of claim 1, wherein said sensors actuate said ignition source.

16. A storage cabinet comprising:
a fire-proof housing defining an interior chamber which houses a rechargeable chemical battery storage compartment configured to receive and charge a rechargeable chemical battery and arranged within said interior chamber so that a void exists between said rechargeable chemical battery storage compartment and any adjacent rechargeable chemical battery storage compartment, wherein said rechargeable chemical battery storage compartment has a compartment access door operably coupled to said rechargeable chemical battery storage compartment and movable between an open position and a closed position which forms an air-tight seal around said compartment access door when secured in said closed position;
an ignition source within said interior chamber; and
a forced-air ventilation system having at least one of an inlet ventilation fan in communication with an inlet port and an exhaust ventilation fan in communication with an exhaust port to channel air into said interior chamber from outside of said storage cabinet and out of said interior chamber and into an exhaust conduit having baffles between said exhaust port and an exhaust vent on the opposing end of said exhaust conduit.

17. The storage cabinet of claim 16, wherein said rechargeable chemical battery storage compartment has interior compartment walls, an exterior compartment walls, and rockwool arranged between said interior and exterior compartment walls.

18. The storage cabinet of claim 17, wherein said interior compartment walls of said rechargeable chemical battery storage compartment are coated with thermal paint.

19. The storage cabinet of claim 17, further comprising sensors selected from the group consisting of smoke sensors and heat sensors.

20. The storage cabinet of claim 19, wherein one of said smoke sensors and said heat sensors actuate said ignition source.
